(19) United States
(12) Patent Application Publication
(10) Pub. No.: US 2006/0224635 A1
(43) Pub. Date: Oct. 5, 2006

(54) Method, system and program product for handling organizational changes

(75) Inventors: Matthew J. Bangel, Poughkeepsie, NY (US); Gregory V. Feeney, Wappingers Falls, NY (US); Robert G. Madsen, Apalachin, NY (US); James A. Martin JR., Endicott, NY (US); Renee C. Mullins, Austin, TX (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/095,998

(22) Filed: Mar. 31, 2005

(51) Int. Cl. G06F 17/30

(52) U.S. Cl. 707/200

(57) ABSTRACT

Under the present invention, a set of files (e.g., two ASCII files) is imported. The files identify the users that are being re-assigned, as well as the business units involved with the reassignment. Information is extracted from the set of files and used to locate affected documents in a set of databases. Once located, the documents are automatically updated to reflect the reassignment of the users.

### BACKGROUND OF THE INVENTION

1. Field of the Invention

The present invention generally relates to information management. Specifically, the present invention relates to a method, system and program product for handling organizational changes.

2. Related Art

In industry, it is common for individuals to be re-assigned between business units. For example, a group of individuals may be re-assigned between departments, divisions, or even between companies. Such organizational changes are becoming increasingly common as companies merge or form joint ventures. However, when such organizational changes are made, corresponding Information Technology (IT) changes must be made. That is, as employees are re-assigned, several pieces of information associated therewith are subject to change. Such information can include, among other things, contact information, electronic mail addresses, reporting chain information, “permission” levels, etc.

In a typical IT infrastructure, computer users will access applications to perform their underlying job functions. Such applications typically utilize “documents” or the like that contain information about the users. When a user is re-assigned, much of this information is likely to change.

Heretofore, the handling of organizational changes has been a manual process. That is, administrators or the like would manually locate affected documents, and then manually make all necessary changes. Such a process can be extremely repetitive and time consuming, especially considering that the same changes can be necessary time and time again. This is a larger concern when handling large-scale organizational changes whereby a high volume of users are re-assigned.

In view of the foregoing, there exists a need for a method, system and program product for handling organizational changes.

### SUMMARY OF THE INVENTION

In general, the present invention provides a method, system and program product for handling organizational changes. Under the present invention, a set (one or more) of files (e.g., ASCII files) is imported. The files identify the users that are being re-assigned, as well as the business units involved with the reassignment. Information is extracted from the set of files and used to locate affected documents in a set of databases. Once located, the documents are automatically updated to reflect the reassignment of the users.

A first aspect of the present invention provides a method for handling organizational changes, comprising: importing a set of files that contain information for identifying a set of users being re-assigned from a first business unit to a second business unit; extracting the information from the set of files; identifying documents that correspond to the set of users in a set of databases using the information; and automatically updating the documents to reflect re-assignment of the set of users from the first business unit to the second business unit.

A second aspect of the present invention provides a system for handling organizational changes, comprising: a file import system for importing a set of files that contain information for identifying a set of users being re-assigned from a first business unit to a second business unit; an information extraction system for extracting the information from the set of files; a document identification system for identifying documents that correspond to the set of users in a set of databases using the information; and a document update system for automatically updating the documents to reflect re-assignment of the set of users from the first business unit to the second business unit.

A third aspect of the present invention provides a program product stored on a computer readable medium for handling organizational changes, the computer readable medium comprising program code for performing the following steps: importing a set of files that contain information for identifying a set of users being re-assigned from a first business unit to a second business unit; extracting the information from the set of files; identifying documents that correspond to the set of users in a set of databases using the information; and automatically updating the documents to reflect re-assignment of the set of users from the first business unit to the second business unit.

A fourth aspect of the present invention provides a method for deploying an application for handling organizational changes, comprising: providing a computer infrastructure being operable to: import a set of files that contain information for identifying a set of users being re-assigned from a first business unit to a second business unit; extract the information from the set of files; identify documents that correspond to the set of users in a set of databases using the information; and automatically update the documents to reflect re-assignment of the set of users from the first business unit to the second business unit.

A fifth aspect of the present invention provides a computer software embodied in a propagated signal for handling organizational changes, the computer software comprising instructions for causing a computer system to perform the following functions: import a set of files that contain information for identifying a set of users being re-assigned from a first business unit to a second business unit; extract the information from the set of files; identify documents that correspond to the set of users in a set of databases using the information; and automatically update the documents to reflect re-assignment of the set of users from the first business unit to the second business unit.

A sixth aspect of the invention provides a business method for handling organizational changes.

The illustrative aspects of the present invention are designed to solve the problems herein described and other problems not discussed, which are discoverable by a skilled artisan.

### BRIEF DESCRIPTION OF THE DRAWINGS

FIG. 1 shows an illustrative system for handling organizational changes according to the present invention.

FIG. 2 shows an illustrative document subject to update according to the present invention.

FIG. 3 shows the illustrative document of FIG. 2 after being updated according to the present invention.

FIG. 4 shows an illustrative method flow diagram according to the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE DRAWINGS

As indicated, the present invention provides a method, system and program product for handling organizational changes. Under the present invention, a set (one or more) of files (e.g., ASCII files) is imported. The files identify the users that are being re-assigned, as well as the business units involved with the reassignment. Information is extracted from the set of files and used to locate affected documents in a set of databases. Once located, the documents are automatically updated to reflect the reassignment of the users.

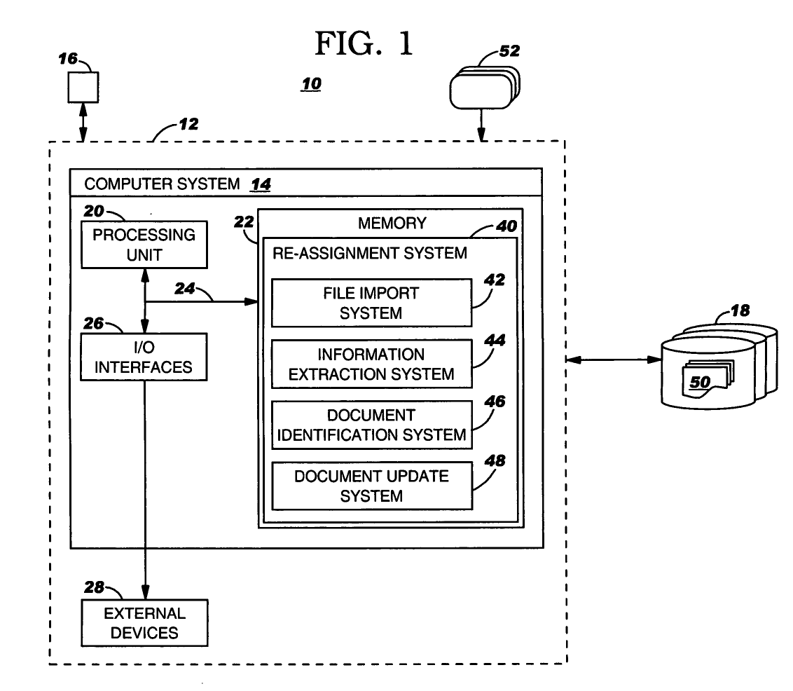

Referring now to FIG. 1, a system 10 for handling organizational changes according to the present invention is shown. As depicted, system 10 includes a computer infrastructure 12, which comprises a computer system 14 that can perform the various process steps described herein. As further depicted, computer infrastructure 12 is in communication with target databases 18 (i.e., a set of one or more databases). In general, target databases 18 are intended to represent any type of computerized storage system capable of providing storage for documents 50 or the like. It should be understood that although not shown, databases 18 could reside within infrastructure 12. They are shown outside of infrastructure 10 to illustrate that the present invention could be implemented by a service provider.

Computer system 14 is intended to represent any type of computer system capable of carrying out the teachings of the present invention. For example, computer system 14 could be a laptop computer, a desktop computer, a workstation, a handheld device, a server, etc. In addition, computer system 14 can be deployed and/or operated by a service provider that is handling organizational changes for customers.

In any event, communication between computer system 14 and target databases 18 could occur directly as shown, or occur over a network (e.g., the Internet, a wide area network (WAN), a local area network (LAN), a virtual private network (VPN), etc. via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. In addition, it should be understood that administrator 16 can directly access computer system 14 as shown, or administrator could operate a separate computer system that communicates with computer system 14 over a network.

Under the present invention, handling of organizational changes is provided. To provide this functionality, re-assignment system 40 is shown implemented on computer system 14 as computer program code. To this extent, computer system 14 is shown including a processing unit 20, a memory 22, a bus 24, and input/output (I/O) interfaces 26. Further, computer system 14 is shown in communication with external I/O devices/resources 28. In general, processing unit 20 executes computer program code, such as re-assignment system 40, that is stored in memory 22. While executing computer program code, processing unit 20 can read and/or write data, to/from memory 22 and/or I/O interfaces 26. Bus 24 provides a communication link between each of the components in computer system 14. External devices 28 can comprise any devices (e.g., keyboard, pointing device, display, etc.) that enables a user to interact with computer system 14 and/or any devices (e.g., network card, modem, etc.) that enables computer system 14 to communicate with one or more other computing devices, such as those in target databases 18 and/or operated by administrator 16.

Computer infrastructure 12 is only illustrative of various types of computer infrastructures for implementing the invention. For example, in one embodiment, computer infrastructure 12 comprises two or more computing devices (e.g., a server cluster) that communicate over a network to perform the various process steps of the invention. Moreover, computer system 14 is only representative of various possible computer infrastructures that can include numerous combinations of hardware. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Still yet, processing unit 20 may comprise a single processing unit, or be distributed across one or more processing units in one or more locations, e.g., on a client and server. Similarly, memory 22 can comprise any combination of various types of data storage and/or transmission media that reside at one or more physical locations. Further, I/O interfaces 26 can comprise any system for exchanging information with one or more external devices 28. Still further, it is understood that one or more additional components (e.g., system software, math co-processing unit, etc.) not shown in FIG. 1 can be included in computer system 14. However, if computer system 14 comprises a handheld device or the like, it is understood that one or more external devices 28 (e.g., a display) could be contained within computer system 14, not externally as shown.

Target databases 18 can actually be any type of systems capable of providing storage for documents 50 under the present invention. To this extent, target databases 18 could include one or more storage devices, such as a magnetic disk drive or an optical disk drive. In another embodiment, target databases 18 include data distributed across, for example, a local area network (LAN), wide area network (WAN) or a storage area network (SAN) (not shown). Although not shown, additional components, such as cache memory, communication systems, system software, etc., may be incorporated into computer system 14. Moreover, although not shown for brevity purposes, and any computer system operated by administrator 16 will likely contain computerized components similar to computer system 14.

Shown in memory 22 of computer system 14 is re-assignment 40, which includes file import system 42, information extraction system 44, document identification system 46, and document update system 48. Operation of each of these systems is discussed further below. However, it is understood that some of the various systems shown in FIG. 1 can be implemented independently, combined, and/or stored in memory for one or more separate computers systems 14 that communicate over a network. Further, it is understood that some of the systems/functionality may not be implemented and/or additional systems/functionality may be included as part of the present invention. Still yet, it is understood that the depiction of these systems shown in FIG. 1 is illustrative only and that the same functionality could be achieved with a different configuration. That is, the functionality of these systems could be combined into fewer systems, or broken down into additional systems. Moreover, in a typical embodiment, re-assignment system 40 (or one or more of its sub-systems) could be implemented as a software agent.

In any event, as indicated above, no previous system provides a way to automatically handle organizational changes. That is, when individuals/users are re-assigned between business units, corresponding updates are performed manually. This is especially time consuming when handling large-scale organizational changes whereby hundreds or thousands of users could be re-assigned. The present invention alleviates this issue. In an illustrative example of the present invention assume that users are being reassigned between business divisions pursuant to a joint venture between two companies. Under the present invention a set (one or more) of files 52 will be imported by file import system 42. In a typical embodiment, set of files 52 comprises at least two files in ASCII format. A first file will identify a list of departments or groups affected by the re-assignment. A second file will contain user details for the users being re-assigned. Such details can include, for example, user identification/serial numbers, contact information, etc. It should be appreciated, however, the this information can be provided in any format (e.g., spreadsheets, files, database entries, etc.).

Once imported, information extraction system 44 will parse the set of files 52 and extract the information needed to identify the affected documents 50 in target databases 18. This information could be any type of information that would identify the users in documents 50. For example, information extraction system 44 could extract user identification numbers, electronic mail addresses, intranet user identifications, etc. Regardless, using this information, document identification system 46 will identify all documents associated with the affected users. For example, assume that pursuant to the re-assignment, 1000 users (e.g., having user identifications numbers 0001-1000) were affected by the re-assignment. Further assume that information extraction system 44 extracted the user identification numbers from set of files 52. Document identification system 46 could compare the extracted user identification numbers to those contained in documents 50. In this case, any document 50 containing one of the extracted user identification numbers would be “identified” as needing to be (or potentially needing to be) updated pursuant to the re-assignment of those users.

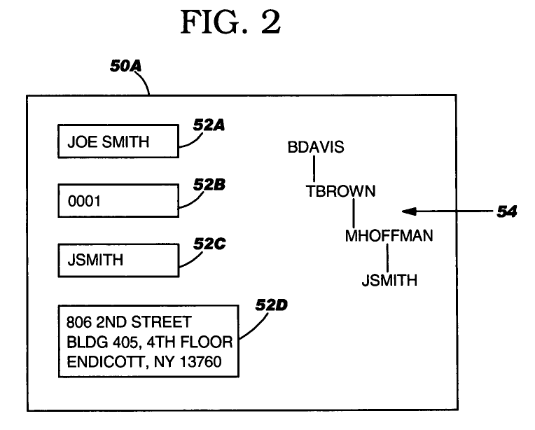

Referring now to FIG. 2, an illustrative document 50A associated with a reassigned user is shown. It should be understood in advance that document 50A is intended to be illustrative only and that document 50A could actually take any format or include any type of information. Moreover, under the present invention, the term “document” is intended to mean any collection (e.g., electronic) of information that is used by one or more computer applications. For example, a document could be one or more records in a target database 18. As mentioned above, the re-assignment of users between business units can impact the way in which (and permissions with which) computer applications are used by the re-assigned users. By updating the documents 50 used by the computer applications, the effect of the re-assignment can be propagated to the computer applications. In any event, it can be seen that document 50A includes fields for the user's name 52A, user identification number 52B, intranet user identification 52C and mailing address 52D. Document 50A also includes a chain of reporting 54 illustrating the management hierarchy in which the user works.

In re-assigning this user to another division, one or more of the pieces of information contained in document 50A could need to be updated. Moreover, there could be any number of additional documents 50 that contain information for the user that also needs to be updated. Once such documents are identified, document update system 48 (FIG. 1) will go through the documents and automatically perform the updates. Under the present invention, document update system 48 could accomplish such updates in any number of ways. For example, document update system 48 could be hard-coded with the identification of target databases 18 as well as a mapping of updates that need to be made. Alternatively, the mappings of updates could be contained in set of files 52. A typically mapping will identify a piece of information that needs to be changed for a user and the value to which that piece of information should be changed. An example of a mapping for an update could be, for employee identification number 0001, change the building number in the mailing address from “405” to “501.” Listed below is sample code for an agent based approached that can be implemented pursuant to a re-assignment of users from Division “33” to “6F” for the following illustrative databases:

CIM=Client Information Manager

CACM=Customer Account Code Manager

WPDM=Workstation Planning and Deployment Manager

‘First the mappings are imported from the files starting with department

Call ImportChangedDepts

‘Now import the Users that have changed

Call ImportChangedEmployees

‘First in WPDM lets loop through all Capital Plan's and move Active Combos to 6F

Call ProcessWPDMCapPlans

‘Second loop through the collection and Set the division of the allocation documents

Call ProcessWPDMAllocDocs

‘In CACM First lets track down duplicates for a department and remove

Call ProcessCACMDuplicates

‘Now lets begin by fixing the division document 33 to 6F

Call ProcessCACMDivDoc

‘Now find all Business Area and Sub Business Area definitions for the 33 division

Call ProcessCACMBAs

‘Parse Department and User conversion file, import and adjust old records, converting them

Call ProcessCACMDeptConvert

‘Finally do a clear check of CACM to verify that there are no documents of Division 33

Call ProcessCACMFinalCheck

‘Change Ship Direct Document affected

Call ProcessCIMMaps(CIM_db)

‘Change New Hire/Transfer/Non Office

Call ProcessCIMNonClient(CIM_db)

‘The CIM employee conversions

‘Call ProcessCIMEmployeeConvert(CArch_db)

‘Finally do a clear check of CIM to verify that there are no documents of Division 33

Call ProcessCIMFinalCheck(CIM_db)

‘Process the change of ITRep and BAR Notes IDs in all databases

Call ProcessNotesIDs(CIM_db,db,WPDM_db,CArch_db,AddressBook)

In the above code, the process flow of the present invention and the sub-tasks can be seen. The general premise is to use existing database information, the set of files 52, and sources outside the target databases 18 (e.g., WPDM, CACM and CIM) to place the information into the documents seamlessly. If the agent is followed from start to completion it can be seen that, initially, departments are converted from the prior division to the new one. Then, user information is calculated from the department information held in this target database (CACM) so the users can be corrected in the user database (CIM). The last change shown above, called “ProcessNotesIDs,” is the access control changes performed by the agent.

In this agent, it can be seen that everything is a conversion between the divisions 33 and 6F. However, this agent can be configured to handle any business unit change as long as the proper import files can be provided. These files are standard for most human resources processes. This methodology can be applied to any (e.g., large-scale) organizational transfer given the environment described.

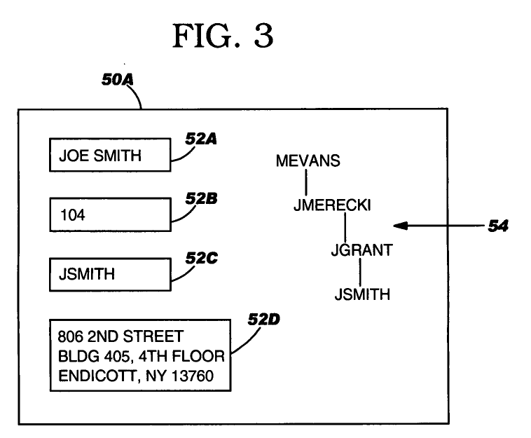

Referring now to FIG. 3, document 50A is shown after being automatically updated by document update system 48 (FIG. 1). As can be seen, several pieces of information have been changed. For example, the user identification number in field 52B has been changed from “0001” to “104,” the building number and floor in field 52B has changed from “BLDG 405, 4^{th} FLOOR” to “BLDG 501, 2^{nd} FLOOR. In addition, the chain of reporting 54 has been changed to reflect a new management structure for the user pursuant to the re-assignment.

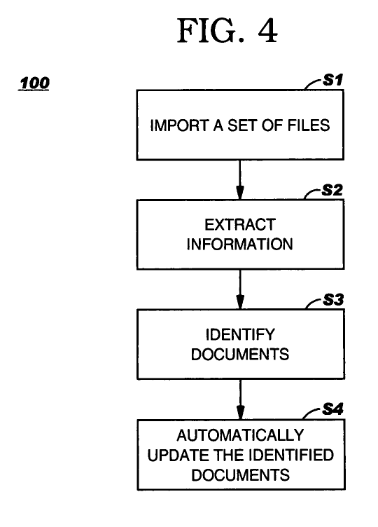

Referring now to FIG. 4, a method flow diagram 100 according to the present invention is shown. First step S1 of method 100 is to import a set of files that contain information for identifying a set of users being re-assigned from a first business unit to a second business unit. Second step S2 is to extract the information from the set of files that is used in third step S3 to identify documents that correspond to users in a set of databases. Once the documents are identified, they are automatically updating the documents to reflect re-assignment of the set of users in fourth step S4.

While shown and described herein as a method and system for handling organizational changes, it is understood that the invention further provides various alternative embodiments. For example, in one embodiment, the invention provides a computer-readable medium that includes computer program code to enable a computer infrastructure to optimize event monitoring filters and metric thresholds. To this extent, the computer-readable medium includes program code that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 22 (FIG. 1) and/or a storage system (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as an Internet Service Provider, could offer to handle organizational changes as described above. In this case, the service provider can create, maintain, support, etc., a computer infrastructure, such as computer infrastructure 12 (FIG. 1) that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a method for handling organizational changes. In this case, a computer infrastructure, such as computer infrastructure 12 (FIG. 1), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 14 (FIG. 1), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for handling organizational changes, comprising:
importing a set of files that contain information for identifying a set of users being re-assigned from a first business unit to a second business unit;
extracting the information from the set of files;
identifying documents that correspond to the set of users in a set of databases using the information; and
automatically updating the documents to reflect re-assignment of the set of users from the first business unit to the second business unit.

2. The method of claim 1, wherein the set of files comprise a first ASCII file and a second ASCII file.

3. The method of claim 2, wherein the first ASCII file contains a list of departments changed pursuant to the re-assignment, and wherein the second ASCII file contains identifications for the set of users.

4. The method of claim 1, wherein the first business unit is a first division and the second business unit is a second division.

5. The method of claim 1, wherein the set of files further specify user details to be changed in the documents pursuant to the re-assignment of the set of users.

6. The method of claim 1, wherein the information comprises employee identifications for the set of users.

7. A system for handling organizational changes, comprising:
a file import system for importing a set of files that contain information for identifying a set of users being re-assigned from a first business unit to a second business unit;
an information extraction system for extracting the information from the set of files;
a document identification system for identifying documents that correspond to the set of users in a set of databases using the information; and
a document update system for automatically updating the documents to reflect re-assignment of the set of users from the first business unit to the second business unit.

8. The system of claim 7, wherein the set of files comprise a first ASCII file and a second ASCII file.

9. The system of claim 8, wherein the first ASCII file contains a list of departments changed pursuant to the re-assignment, and wherein the second ASCII file contains identifications for the set of users.

10. The system of claim 7, wherein the first business unit is a first division and the second business unit is a second division.

11. The system of claim 7, wherein the set of files further specify user details to be changed in the documents pursuant to the re-assignment of the set of users.

12. The system of claim 7, wherein the information comprises employee identifications for the set of users.

13. A program product stored on a computer readable medium for handling organizational changes, the computer readable medium comprising program code for performing the following steps:
importing a set of files that contain information for identifying a set of users being re-assigned from a first business unit to a second business unit;
extracting the information from the set of files;
identifying documents that correspond to the set of users in a set of databases using the information; and
automatically updating the documents to reflect re-assignment of the set of users from the first business unit to the second business unit.

14. The program product of claim 13, wherein the set of files comprise a first ASCII file and a second ASCII file.

15. The program product of claim 14, wherein the first ASCII file contains a list of departments changed pursuant to the re-assignment, and wherein the second ASCII file contains identifications for the set of users.

16. The program product of claim 13, wherein the first business unit is a first division and the second business unit is a second division.

17. The program product of claim 13, wherein the set of files further specify user details to be changed in the documents pursuant to the re-assignment of the set of users.

18. The program product of claim 13, wherein the information comprises employee identifications for the set of users.

19. A method for deploying an application for handling organizational changes, comprising:
providing a computer infrastructure being operable to:
import a set of files that contain information for identifying a set of users being re-assigned from a first business unit to a second business unit;
extract the information from the set of files;
identify documents that correspond to the set of users in a set of databases using the information; and
automatically update the documents to reflect re-assignment of the set of users from the first business unit to the second business unit.

20. Computer software embodied in a propagated signal for handling organizational changes, the computer software comprising instructions for causing a computer system to perform the following functions:
import a set of files that contain information for identifying a set of users being re-assigned from a first business unit to a second business unit;
extract the information from the set of files;
identify documents that correspond to the set of users in a set of databases using the information; and
automatically update the documents to reflect re-assignment of the set of users from the first business unit to the second business unit.
